(19) United States
(12) Patent Application Publication
(10) Pub. No.: US 2024/0324518 A1
(43) Pub. Date: Oct. 3, 2024

(54) Detachable flowerpot

(71) Applicant: Taizhou PuShangQu Gardening Products Co., Ltd., Taizhou (CN)

(72) Inventors: Jing Wu, Taizhou (CN); YuXuan Wu, Taizhou (CN); Huanchao Chen, Taizhou (CN)

(21) Appl. No.: 18/738,012

(22) Filed: Jun. 9, 2024

(30) Foreign Application Priority Data
May 15, 2024 (CN) 202421055349.0

(51) Int. Cl. A01G 9/02

(52) U.S. Cl. CPC A01G 9/02

(57) ABSTRACT

The present invention discloses a detachable flowerpot, including a flowerpot body. The bottom of the flowerpot body is provided with a pot bottom, a planting chamber is formed inside the flowerpot body, the flowerpot body is composed of a plurality of detachable pot rings, the detached pot rings can be nested together, and a detachable structure is arranged between the adjacent pot rings. The detachable flowerpot has the following advantages: the structure is simple and reasonable; the pot body is composed of a plurality of detachable pot rings, the pot rings are connected by the detachable structure, and the sealing structure is arranged at the connection to ensure the sealing property of the flowerpot; and when selling and transporting, the pot rings are nested together to greatly reduce the packaging volume during transportation, thereby reducing transportation costs.

### TECHNICAL FIELD

The present invention relates to the field of flowerpot manufacturing technology, and specifically to a detachable flowerpot.

### BACKGROUND

As a type of vessels for planting flowers and plants, flowerpots are often seen or used in daily life. Conventional flowerpots often employ an integrated structure. In order to save space during transportation, most flowerpots are designed as a conical structure reduced from top to bottom. In this way, several flowerpots can be stacked together during transportation to greatly reduce transportation space. With the rise of on-line shopping, on-line sales have become the main sales channel for many merchants. Individuals buy a few, and even only one flowerpot at a time. The existing integrated flowerpots have a large packaging volume and high transportation cost. Therefore, the structures of the existing flowerpots need to be further improved.

### SUMMARY

The present invention aims to make up for the above shortcomings, and to disclose

to the society a detachable flowerpot that has a reasonable structure, is convenient to disassemble and assemble, and can greatly save space during sales and transportation.

The technical solution of the present invention is implemented as follows:

A detachable flowerpot, including a flowerpot body, the bottom of the flowerpot body being provided with a pot bottom, a planting chamber being formed inside the flowerpot body, wherein the flowerpot body is composed of a plurality of detachable pot rings, the detached pot rings can be nested together, and a detachable structure is arranged between the adjacent pot rings; and the detachable structure includes a first connecting portion arranged at a lower end of the pot ring and a second connecting portion arranged at an upper end of the pot ring and adapted to the first connecting portion, the first connecting portion and the second connecting portion are connected and fixed, and a sealing structure is arranged between the first connecting portion and the second connecting portion.

Measures to further optimize the technical solution are as follows:

As an improvement, the first connecting portion is provided with a hooked portion, and the second connecting portion is provided with a groove adapted to the hooked portion; after the first connecting portion and the second connecting portion are fixed, an accommodating chamber is formed between the first connecting portion and the second connecting portion; and a sealing ring is arranged inside the accommodating chamber. A detachable connection is achieved by the cooperation of the hooked portion on the first connecting portion and the groove on the second connecting portion, and sealing at the connection is achieved by the sealing ring.

As an improvement, both the first connecting portion and the second connecting portion are of ring structures, and the ring structure of the first connecting portion is provided with a gap. The gap can improve the deformability of the first connecting portion and facilitate buckling of the hooked portion into the groove.

As an improvement, the first connecting portion is provided with a first step surface, and the second connecting portion is provided with a second step surface adapted to the first step surface. The first step surface and the second step surface form a step at the connection surface to increase the flexibility of contact surfaces and improve the sealing property of the contact surfaces.

As an improvement, the lower surface of the hooked portion is an inclined plane.

As an improvement, the first connecting portion and the second connecting portion are fixed by a fixing member, and a sealing ring is arranged between the first connecting portion and the second connecting portion. The fixing member is preferably a screw.

As an improvement, the first connecting portion is provided with a first groove, the second connecting portion is provided with a second groove, and the first connecting portion and the second connecting portion are fixed by a clamp after being coupled; and the first groove and the second groove are coupled to form a sealing ring groove in which the sealing ring is arranged.

As an improvement, the first connecting portion and the second connecting portion are fixed by adhesive bonding, and the adhesive solidifies to form a sealing structure.

As an improvement, the first connecting portion is provided with a support portion, and a detachable partition plate is mounted on the support portion. The partition plates can partition the space inside the planting chamber to adapt to the planting of plants in different quantities of soil.

As an improvement, the periphery of the pot ring is a conical surface with an upper end inclined outwards.

Compared with existing technologies, the advantages of the present invention are as follows:

The detachable flowerpot of the present invention has a simple and reasonable structure; the pot body is composed of a plurality of detachable pot rings, the pot rings are connected by the detachable structure, and the sealing structure is arranged at the connection, so as to ensure the sealing property of the flowerpot and prevent the loss of moisture in soil from the connection during plant planting; and when selling and transporting, the pot rings are nested together to greatly reduce the packaging volume during transportation, thereby reducing transportation costs.

### BRIEF DESCRIPTION OF THE DRAWINGS

FIG. 1 is a three-dimensional structural diagram of Embodiment 1 of the present invention;

FIG. 2 is a cross-sectional view of Embodiment 1 of the present invention;

FIG. 3 is an enlarged view of part A in FIG. 1;

FIG. 4 is a schematic structural diagram of a single flowerpot during transportation and packaging in Embodiment 1 of the present invention;

FIG. 5 is a schematic structural diagram of a plurality of flowerpots during transportation and packaging in Embodiment 1 of the present invention;

FIG. 6 is a three-dimensional structural diagram of Embodiment 2 of the present invention;

FIG. 7 is a cross-sectional view of Embodiment 2 of the present invention;

FIG. 8 is an enlarged view of part B in FIG. 7;

FIG. 9 is a schematic diagram of an integrated structure of partition plates and pot rings in the present invention;

FIG. 10 is an enlarged view of part C in FIG. 9;

FIG. 11 is a cross-sectional structural diagram of Embodiment 3 of the present invention;

FIG. 12 is an enlarged view of part D in FIG. 11;

FIG. 13 is a cross-sectional structural diagram of Embodiment 4 of the present invention;

FIG. 14 is an enlarged view of part E in FIG. 13;

FIG. 15 is a cross-sectional structural diagram of Embodiment 5 of the present invention; and

FIG. 16 is an enlarged view of part F in FIG. 15.

Names of reference numerals in the accompanying drawings of the present invention are as follows:

Flower pot body 1, pot bottom la, planting chamber 1b, pot ring 11, conical surface 11a, first connecting portion 2, gap 2a, first groove 2b, hooked portion 21, inclined plane 21a, first step surface 22, support portion 23, second connecting portion 3, second groove 3a, groove 31, sealing ring 4, accommodating chamber 4a, fixing member 5, clamp 6, and partition plate 7.

### DETAILED DESCRIPTION OF THE EMBODIMENTS

The present invention will be further described in detail below in conjunction with the accompanying drawings:

The following description is used for disclosing the present invention that can be implemented by those skilled in the art. Preferred embodiments in the following description are for examples only, and those skilled in the art can conceive other obvious variations. The basic principles of the present invention defined in the following description can be applied to other embodiments, variations, improvements, equivalents, and other technical solutions that do not deviate from the spirit and scope of the present invention.

Those skilled in the art should understand that, in the disclosure of the present invention, the orientations or positions indicated by the terms “longitudinal”, “lateral”, “upper”, “lower”, “left”, “right”, “front”, “rear”, “vertical”, “horizontal”, “top”, “bottom”, “inner”, “outer”, etc. are based on the orientations or positional relationships shown in the accompanying drawings, and are only for facilitating description and simplifying the description of the present invention, rather than indicating or implying that a device or element referred to must have a particular orientation or be constructed and operated in a particular orientation, and therefore, the above terms cannot be interpreted as limitations on the present invention.

It can be understood that the term “a” should be understood as “at least one” or “one or more”, that is, in one embodiment, the number of an element may be one, and in another embodiment, the number of the element may be more than one, so the term “one” cannot be understood as a limitation on the number.

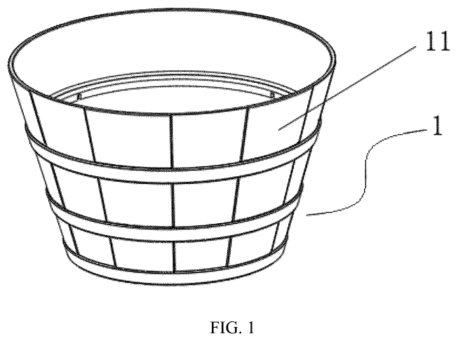

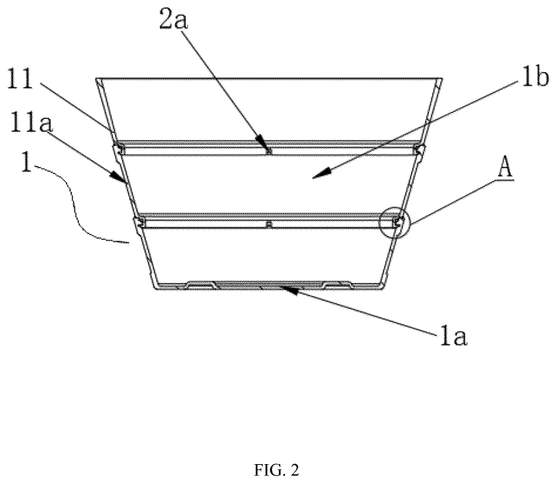

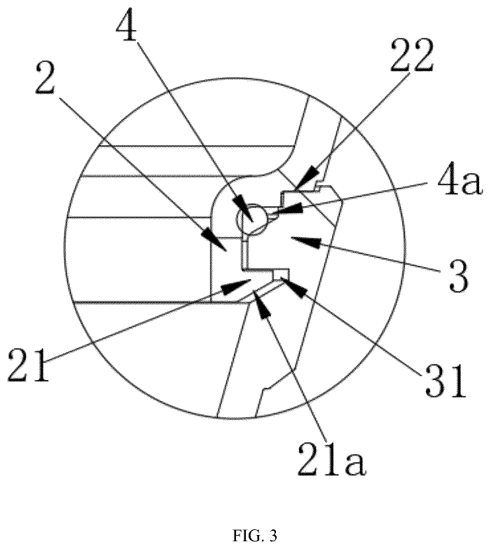

Embodiment 1: As shown in FIG. 1 to FIG. 5, a detachable flowerpot includes a flowerpot body 1, the bottom of the flowerpot body 1 is provided with a pot bottom 1a, a planting chamber 1b is formed inside the flowerpot body 1, the flowerpot body 1 is composed of a plurality of detachable pot rings 11, the detached pot rings 11 can be nested together, and a detachable structure is arranged between the adjacent pot rings; and the detachable structure includes a first connecting portion 2 arranged at a lower end of the pot ring 11 and a second connecting portion 3 arranged at an upper end of the pot ring 11 and adapted to the first connecting portion 2, the first connecting portion 2 and the second connecting portion 3 are connected and fixed, and a sealing structure is arranged between the first connecting portion 2 and the second connecting portion 3.

In this embodiment, the first connecting portion 2 is provided with a hooked portion 21, and the second connecting portion 3 is provided with a groove 31 adapted to the hooked portion 21; after the first connecting portion 2 and the second connecting portion 3 are fixed, an accommodating chamber 4a is formed between the first connecting portion 2 and the second connecting portion 3; and a sealing ring 4 is arranged inside the accommodating chamber 4a.

As an extension, the positions of the hooked portion 21 and the groove 31 can be exchanged to achieve reliable connection, too. That is, the hooked portion 21 is provided on the second connecting portion 3, and the groove 31 is provided on the first connecting portion 2.

Both the first connecting portion 2 and the second connecting portion 3 are of ring structures, and the ring structure of the first connecting portion 2 is provided with a gap 2a. The gap 2a segments the ring structure to improve the deformability of the first connecting portion 2 and to facilitate buckling of the hooked portion 21 into the groove 31.

The first connecting portion 2 is provided with a first step surface 22, and the second connecting portion 3 is provided with a second step surface 32 adapted to the first step surface 22. The step surfaces increase the flexibility of contact surfaces, which can further prevent the loss of water in the soil from the connection.

The lower surface of the hooked portion 21 is an inclined plane 21a. The inclined plane 21a also facilitates buckling of the hooked portion 21 into the groove 31.

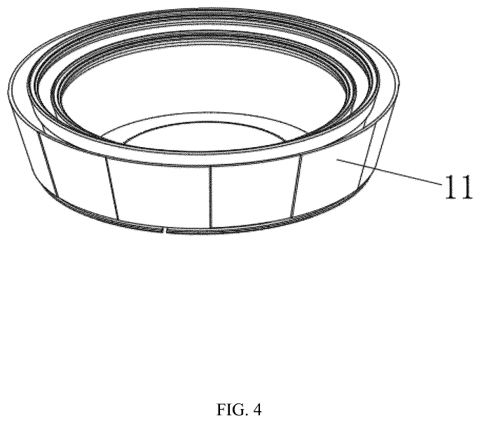

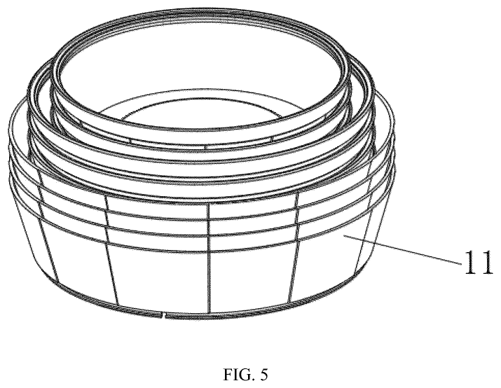

The flowerpot body 1 of the detachable flowerpot in the present invention is composed of a plurality of detachable pot rings 11. As shown in FIG. 4, the pot rings 11 can be nested together to reduce the packaging volume. Not only can the pot rings 11 of a single flowerpot be nested together, but as shown in FIG. 5, the pot rings 11 of a plurality of flowerpots can also be nested together, which can greatly reduce the packaging volume during sales and transportation, thereby reducing transportation costs.

During use, the pot rings 11 are sequentially connected in order of size. In this embodiment, the assembled pot rings 11 have an inverted truncated cone structure, with a conical surface 11a inclined outwards from the upper end on its periphery. In order to ensure the waterproofing and sealing properties at the connection, a sealing ring 4 is arranged between the first connecting portion 2 and the second connecting portion 3 in this embodiment to implement sealing.

In this embodiment, the outer surface of the flowerpot body 1 is patterned to form a simulated wooden barrel structure.

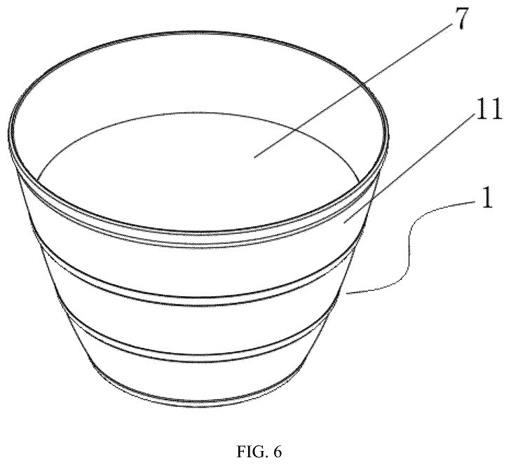

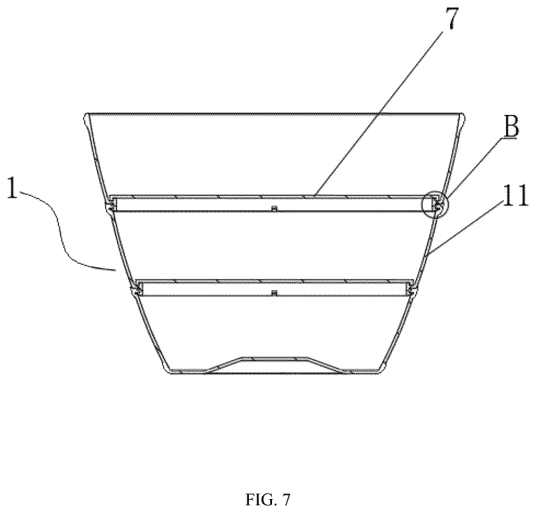

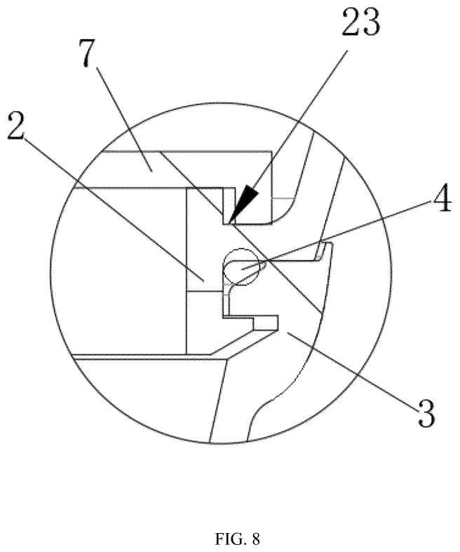

Embodiment 2: As shown in FIG. 6 to FIG. 8, the structure of the flowerpot in this embodiment is similar to that in Embodiment 1, except that the first connecting portion 2 is provided with a support portion 23, and a detachable partition plate 7 is mounted on the support portion 23. The partition plate 7 only needs to be placed on the support portion 23, without additional fixation.

The periphery of the flowerpot is a conical surface, and the cross-sectional area of each connection is different, so a partition plate 7 of different area is mounted at each connection. Different plants need different quantities of soil. The partition plates 7 can partition the space inside the planting chamber 1b to form planting chambers 1b of different sizes, so as to meet the planting requirements of different plants.

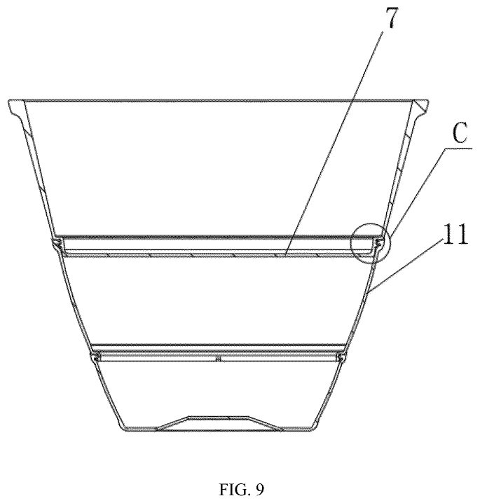

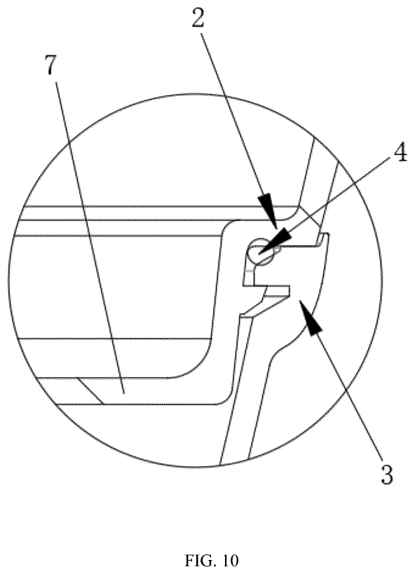

As an extension, as shown in FIG. 9 to FIG. 10, the partition plates 7 can form an integrated structure with the pot rings 11. Similarly, the space of the integrated structure is partitioned by the partition plates 7.

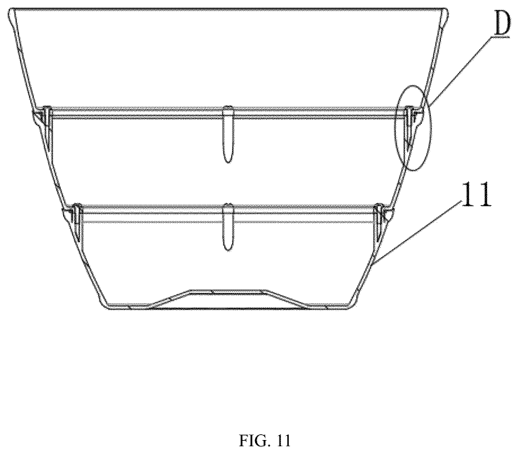

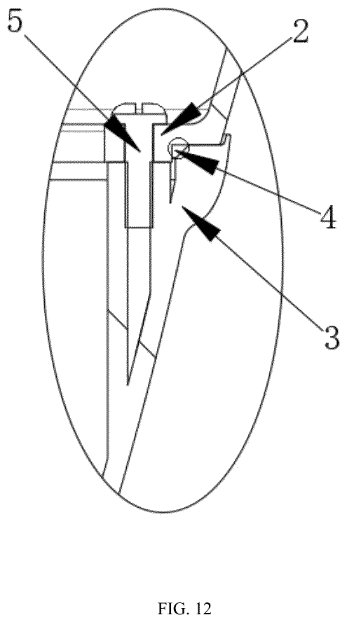

Embodiment 3: As shown in FIG. 11 to FIG. 12, the structure of the flowerpot in this embodiment is similar to that in Embodiment 1, except that in this embodiment, the first connecting portion 2 and the second connecting portion 3 are fixed by a fixing member 5, and a sealing ring 4 is arranged between the first connecting portion 2 and the second connecting portion 3. The fixing member 5 is preferably a screw.

In this embodiment, the first connecting portion 2 and the second connecting portion 3 are fixed by a screw after being spliced, to ensure structural connection and reliable fixation. The sealing ring 4 is also arranged between the first connecting portion 2 and the second connecting portion 3 to ensure the sealing property of the connection.

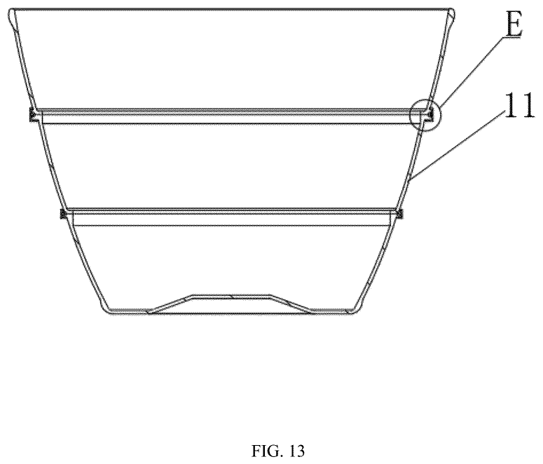

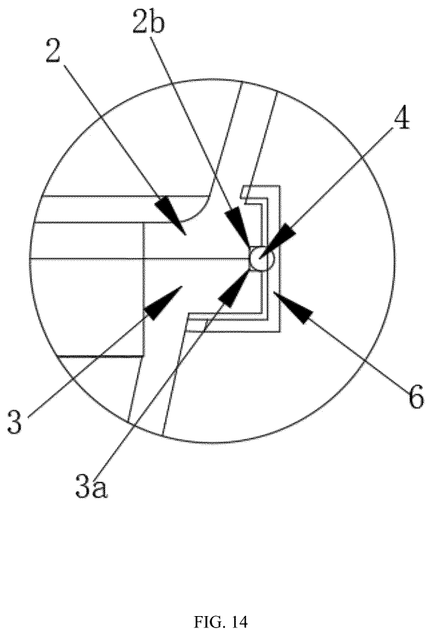

Embodiment 4: As shown in FIG. 13 to FIG. 14, the structure of the flowerpot in this embodiment is similar to that in Embodiment 1, except that in this embodiment, the first connecting portion 2 is provided with a first groove 2b, the second connecting portion 3 is provided with a second groove 3a, and the first connecting portion 2 and the second connecting portion 3 are fixed by a clamp 6 after being coupled; and the first groove 2b and the second groove 3a are coupled to form a sealing ring groove in which a sealing ring 4 is arranged.

In this embodiment, the first connecting portion 2 and the second connecting portion 3 are fixed from the periphery by the clamp 6 after being spliced, and the sealing ring 4 is also used to ensure the sealing property of the connection.

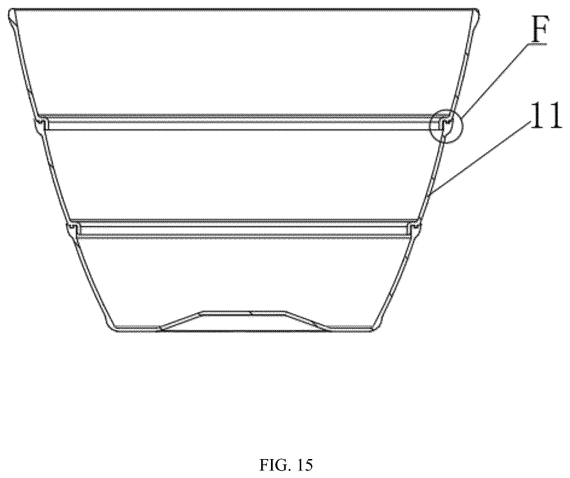

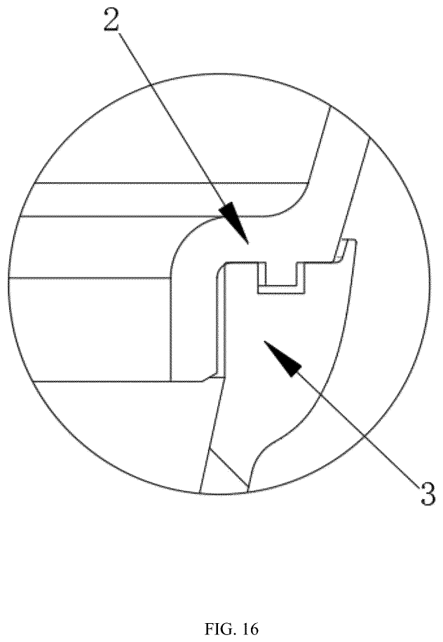

Embodiment 5: As shown in FIG. 15 to FIG. 16, the structure of the flowerpot in this embodiment is similar to that in Embodiment 1, except that in this embodiment, the first connecting portion 2 and the second connecting portion 3 are fixed by adhesive bonding, and the adhesive solidifies to form a sealing structure.

In this embodiment, the adhesive solidifies to form an adhesive layer as a sealing structure to achieve a sealing effect, too. The second connecting portion 3 is provided with a groove. The groove is conducive to the formation of the adhesive layer. When disassembling, the bonded pot rings 11 are separated only by an external force. The adhesive layer is peeled off after separation, and the adhesive is applied for fixation during next assembly.

The above are only the preferred embodiments of the present invention and are not intended to limit the implementation and protection scope of the present invention. Those skilled in the art should recognize that all solutions obtained by equivalent substitutions and obvious changes made using the description and illustrations of the present invention should fall within the protection scope of the present invention.

1. A detachable flowerpot, comprising a flowerpot body (1), the bottom of the flowerpot body (1) being provided with a pot bottom (1a), a planting chamber (1b) being formed inside the flowerpot body (1), characterized in that the flowerpot body (1) is composed of a plurality of detachable pot rings (11), the detached pot rings (11) can be nested together, and a detachable structure is arranged between the adjacent pot rings; and the detachable structure comprises a first connecting portion (2) arranged at a lower end of the pot ring (11) and a second connecting portion (3) arranged at an upper end of the pot ring (11) and adapted to the first connecting portion (2), the first connecting portion (2) and the second connecting portion (3) are connected and fixed, and a sealing structure is arranged between the first connecting portion (2) and the second connecting portion (3).

2. The detachable flowerpot according to claim 1, characterized in that the first connecting portion (2) is provided with a hooked portion (21), and the second connecting portion (3) is provided with a groove (31) adapted to the hooked portion (21); after the first connecting portion (2) and the second connecting portion (3) are fixed, an accommodating chamber (4a) is formed between the first connecting portion (2) and the second connecting portion (3); and a sealing ring (4) is arranged inside the accommodating chamber (4a).

3. The detachable flowerpot according to claim 2, characterized in that both the first connecting portion (2) and the second connecting portion (3) are of ring structures, and the ring structure of the first connecting portion (2) is provided with a gap (2a).

4. The detachable flowerpot according to claim 3, characterized in that the first connecting portion (2) is provided with a first step surface (22), and the second connecting portion (3) is provided with a second step surface (32) adapted to the first step surface (22).

5. The detachable flowerpot according to claim 4, characterized in that the lower surface of the hooked portion (21) is an inclined plane (21a).

6. The detachable flowerpot according to claim 1, characterized in that the first connecting portion (2) and the second connecting portion (3) are fixed by a fixing member (5), and a sealing ring (4) is arranged between the first connecting portion (2) and the second connecting portion (3).

7. The detachable flowerpot according to claim 1, characterized in that the first connecting portion (2) is provided with a first groove (2b), the second connecting portion (3) is provided with a second groove (3a), and the first connecting portion (2) and the second connecting portion (3) are fixed by a clamp (6) after being coupled; and the first groove (2b) and the second groove (3a) are coupled to form a sealing ring groove in which the sealing ring (4) is arranged.

8. The detachable flowerpot according to claim 1, characterized in that the first connecting portion (2) and the second connecting portion (3) are fixed by adhesive bonding, and the adhesive solidifies to form a sealing structure.

9. The detachable flowerpot according to claim 1, characterized in that the first connecting portion (2) is provided with a support portion (23), and a detachable partition plate (7) is mounted on the support portion (23).

10. The detachable flowerpot according to claim 1, characterized in that the periphery of the pot ring (11) is a conical surface (11a) with an upper end inclined outwards.
